(19) United States
(12) Patent Application Publication
(10) Pub. No.: US 2008/0148214 A1
(43) Pub. Date: Jun. 19, 2008

(54) Method and system for configuring FPGAs from VHDL code with reduced delay from large multiplexers

(76) Inventors: Jerry W. Yancey, Rockwall, TX (US); Yea Zong Kuo, Rockwall, TX (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 11/639,784

(22) Filed: Dec. 15, 2006

(51) Int. Cl. G06F 17/50

(52) U.S. Cl. 716/18

(57) ABSTRACT

Systems and methods are disclosed for mapping large multiplexers defined in VHDL (Very high speed integrated circuit Hardware Description Language) code to circuitry within an FPGA (field programmable gate array) in order to reduce the time required to synthesize and decompose such VHDL structures into FPGAs. It was recognized that large multiplexers within a VHDL device description can cause significant delays in the synthesis and decomposition processes for forming FPGAs based upon the VHDL code. By splitting the multiplexer into a multiple level cascaded multiplexer structure, a significant reduction can be achieved in the time it takes to accomplish the synthesis and decomposition process for FPGAs. The determination of whether the multiplexer is large and should be split can be made by a user, by tool automation, or by both.

### TECHNICAL FIELD OF THE INVENTION

This invention relates to implementing multiplexers in field programmable gate array (FPGA) circuitry and, more particularly, to the use of a hardware description language to define large multiplexers for FPGA circuitry and subsequent synthesis of FPGAs.

### BACKGROUND

Hardware description languages (HDLs) are used to simulate or model electronic circuits and systems. Examples of HDLs include Very High Speed Integrated Circuit (VHSIC) Hardware Description Language (VHDL) and VERILOG. HDLs are concurrent in nature, meaning that multiple operations occur in parallel at the same time. Because HDLs are based on the principle of concurrence, they are capable of describing and modeling many different processes which are running simultaneously. For example, an HDL language may be used to model or simulate a system or circuit by utilizing a hierarchy that includes multiple entities (Boolean equations, registers, control logic, complex event sequences) corresponding to various parts of the modeled circuit or system. During simulation, these multiple entities operate in parallel in a timed manner that may be adjusted by the user to simulate the system or circuit.

A field programmable gate array (FPGA) is a semiconductor device having programmable logic components and programmable interconnects. These components can be programmed to duplicate the functionality of basic logic gates or more complex combinational functions. These programmable logic components can include memory elements. VHDL is often used as a design-entry language for FPGAs and application-specific integrated circuits (ASICs) in electronic design automation of digital circuits. VHDL code is written to provide a high level hardware description of the operation of the device. The VHDL code is then synthesized to form hardware definitions. These hardware definitions are then decomposed or mapped to the actual FPGA circuitry.

One advantage of VHDL is that it allows the behavior of the designed system to be modeled and simulated or verified before synthesis tools translate the design into real hardware. Thus, VHDL is a general purpose language, requiring a simulator on which to run the code. Also, VHDL allows the description of a concurrent system. When a VHDL model is translated or synthesized into hardware definitions and then mapped onto an FPGA, actual hardware is being configured. This synthesis and decomposition (mapping) can be very time consuming for complex VHDL models.

### SUMMARY OF THE INVENTION

Systems and methods are provided for configuring FPGA (field programmable gate array) circuitry from VHDL (Very high speed integrated circuit Hardware Description Language) code with reduced delay from large multiplexers. It was recognized that large multiplexers within a VHDL device description were causing significant delays in the synthesis and decomposition processes for forming FPGAs based upon the VHDL code. As described herein, by splitting the multiplexer into a multiple level cascaded multiplexer structure, a significant reduction is achieved in the time required to synthesize the VHDL code into hardware descriptions and then to decompose or map the hardware descriptions, including the multiplexer structure, to an FPGA. Although easy to define, VHDL multiplexers for FPGA implementation are problematic to implement because their ratio of input/output connections to gates is large compared to other functions such as adders or multipliers. In particular, large multiplexer structures (e.g., 8 or more input sources and/or output destinations, 16 or more bits wide for the total number of input/output signals, or some combination of the two) can cause issues with FPGA implementations because of limited connection routing resources.

As described below, to reduce the time delay in the synthesis and decomposition process from VHDL code to FPGA circuitry, multiplexers are split into two or more levels of cascaded multiplexers. And this split can be implemented in a variety of ways. For example, this split can be made in the VHDL code itself, or this split can be automated as part of FPGA synthesis and decomposition tools used for processing VHDL code. As such, the determination of whether the multiplexer is large and requires splitting can be made by a user, by a tool, or by both. The splitting, therefore, can occur automatically once a system determines it is desirable, can be done manually by a user when the user detects that the multiplexer so large as to cause significant delays, and/or by a user when informed by the tool that the multiplexer so large that it may cause or is causing significant delays. As described below, other features and variations can be implemented, if desired, and a related systems method can be utilized, as well.

### DESCRIPTION OF THE DRAWING

It is noted that the appended drawings illustrate only exemplary embodiments of the invention and are, therefore, not to be considered limiting of its scope, for the invention may admit to other equally effective embodiments.

FIG. 1A (prior art) is a flow diagram of a processing architecture for converting VHDL code into hardware definitions and then decomposing those definitions into circuitry within an FGPA.

FIG. 1B (prior art) block diagram showing a large multiplexer.

FIG. 2A is a flow diagram of a processing architecture for converting VHDL code into hardware definitions and then decomposing those definitions into circuitry within an FGPA where a large multiplexer is split into multiple levels prior to synthesis and decomposition process.

FIG. 2B is a flow diagram of a processing architecture for converting VHDL code into hardware definitions and then decomposing those definitions into circuitry within an FGPA where a large multiplexer is split into multiple levels as part of the synthesis and decomposition process.

FIG. 2C is a block diagram showing a large multiplexer split into multiple levels of cascaded multiplexers.

FIG. 3 is a block diagram for a VHDL tool configured to identify and split large multiplexers within VHDL code.

### DETAILED DESCRIPTION OF THE INVENTION

The present invention provides systems and methods for splitting large multiplexers defined in Very High Speed Integrated Circuit (VHSIC) Hardware Description Language (VHDL) to reduce delay in synthesizing and decomposing VHDL code into field programmable gate array (FPGA) circuitry. The large multiplexer can be split at a variety of steps, including within the VHDL code itself prior to synthesis and decomposition or, if desired, during the synthesis and decomposition process.

As stated above, one circuit structure that was found to cause significant delays in synthesis and decomposition of VHDL code into FPGA circuitry was a large multiplexer structure. A multiplexer is a device that receives signals from a plurality of sources and then selects one of those signal sources for an output stream based upon a selection signal. In other words, one set of input signals is passed through as to become the output signals of the multiplexer based on the values of one or more selection signal inputs received by the multiplexer.

As a more particular example, it was found that a multiplexer having over 16 input signal sources with each signal source provide 32 signals lines caused synthesis/decomposition delays in the order of hours. In one example, one VHDL coded model took about 20 hours to synthesize and decompose into an FPGA. It was found by investigation that a significant cause for this delay was a large multiplexer defined within the VHDL code. There were multiple instances of this multiplexer in the design. When this large multiplexer was split into two-levels with two multiplexers at the first level and another multiplexer at a second level, the synthesis/decomposition process was reduced to the order of minutes. In the above example, this time was reduced to about 5 minutes. The existing FPGA related synthesis and decomposition tools simply do not handle these large multiplexer structures very well and do not recognize the potential processing delays caused by their inclusion within the VHDL code. It is further noted that the above examples were associated with a Xilinx FGPA (e.g., Xilinx Virtex-II Pro® XC2VP50 FPGA device available from Xilinx, Inc. of San Jose, Calif.) and associated synthesis and decomposition tools. In addition, although any multiplexer within the VHDL code may give rise to a significant processing delay, in particular, a large multiplexer structure will likely cause processing delays. As discussed in more detail below, a multiplexer can be identified as a large multiplexer based upon one or more parameters. For example, a multiplexer can be determined to be a large multiplexer that may cause undesirable processing delays when the total number of input sources and/or output destinations become 8 or more, when the multiplexer becomes 16 bits or more wide for the total number of input/output signals, or some combination of the two.

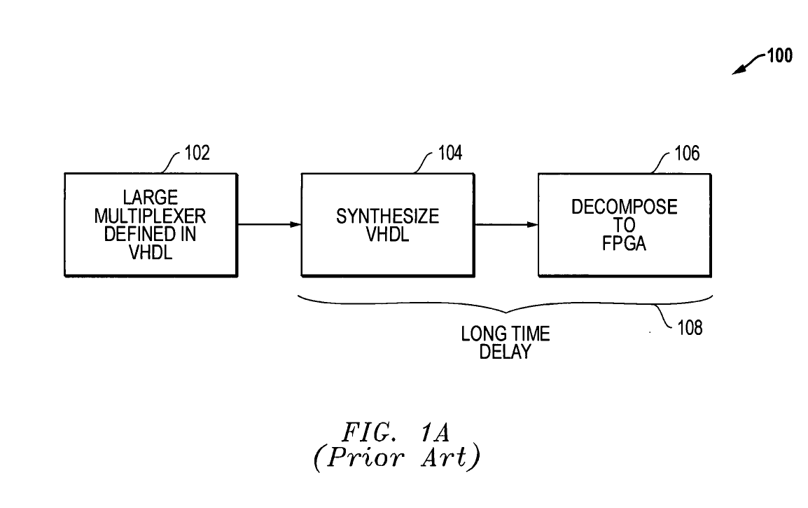

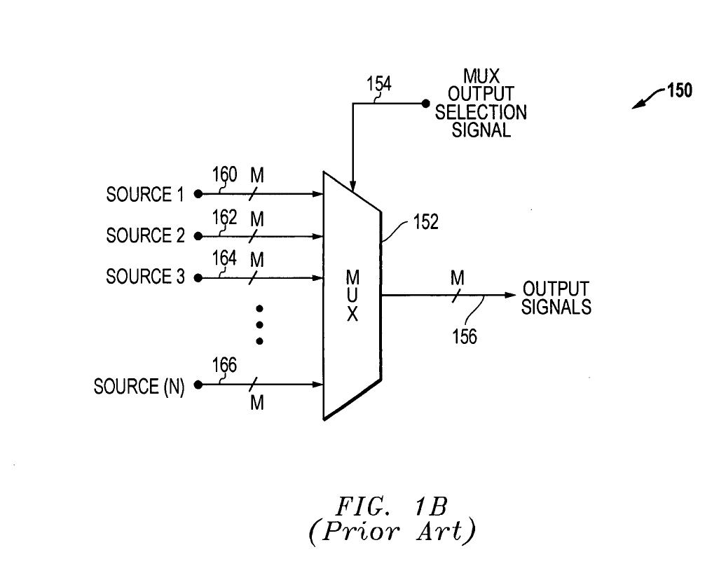

FIG. 1A (prior art) provides a block diagram for a previously existing standard VHDL synthesis and decomposition process 100 in forming a large multiplexer within an FPGA. In step 102, a large multiplexer is defined in VHDL, for example, as part of a larger device configured to operate and perform desired functions. In step 104, the VHDL is synthesized using a synthesis tool to form hardware definitions of gates and lines associated with the hardware described in the VHDL code, including the large multiplexer. In step 106, the synthesized hardware is the decomposed or mapped into an FPGA to form an integrated circuit device programmed to perform the desired functions as described in the VHDL code, including the large multiplexer. This prior method of synthesizing and mapping multiplexers from VHDL to FPGAs can function well; however, when multiplexers become large in the number of inputs and/or outputs that have to be handled, the multiplexers can quickly become difficult to map to circuitry within an FPGA. As shown in FIG. 1A, a long time delay 108 is then associated with the synthesis and decomposition process to take VHDL code and create a programmed FPGA.

FIG. 1B (prior art) is a block diagram for a multiplexer structure 150 that would result from a synthesis and decomposition process according to FIG. 1A. Multiplexer (MUX) 152 receives input signals from a plurality (N) of signal sources. In particular, as shown, multiplexer 152 receives M signal lines 160 from SOURCE1, M signal lines 162 from SOURCE2, M signal lines 164 from SOURCE3, . . . through M signal lines 166 from SOURCE(N). The multiplexer 154 then receives the MUX output selection signal 154 that acts to select which of the input signal sources it passes on as the M output signals 156 from the multiplexer 154. As used in FIG. 1, “N” represents an integer number of signal sources, and “M” represents an integer number of signals lines associated with each signal source. It is understood “N” and “M” could be any integer. As discussed above, however, a multiplexer defined in VHDL may cause undesirable processing delays. For example, when M is 16 or greater, there is a likelihood that the multiplexer will cause significant processing delays. In the example mentioned above where significant delays occurred, for example, “M” was 32 for each signal source. In addition, when the total number of input signals and/or output signals becomes 16 or greater, there is a likelihood that the multiplexer will cause significant processing delays. Further, when N is 8 or more, there is a likelihood that the multiplexer will cause significant processing delays. As discussed above, therefore, the size and complexity of this large multiplexer 152 can significantly delay the synthesis and decomposition process of realizing this circuitry in an FPGA.

Large multiplexers can be defined in VHDL code, as desired. Below is an example VHDL code for a large multiplexer have 32 input lines per signal source.

| type | bus_array is array (natural range <>) of vector(31 downto 0); | |
|---|---|---|
| subtype | MUX_SEL_RANGE | is integer range 0 to gNUM_SOURCES-1; |
| signal | sMUX_SEL_INT | :MUX_SEL_RANGE; |
| IF_BUS | :in | bus_array(0 to gNUM_SOURCES-1); |
| MUX_BUS | :out | vector(31 downto 0); |

| | |
|---|---|
| MUX_BUS<= | sIF_BUS(sMUX_SEL_INT) |

This VHDL language represents a definition for a multiplexer of FIG. 1B where M is 32. As part of a broader device description, VHDL code defining large multiplexers, such as this code, can cause significant delays in the synthesis and decomposition process for FPGAs.

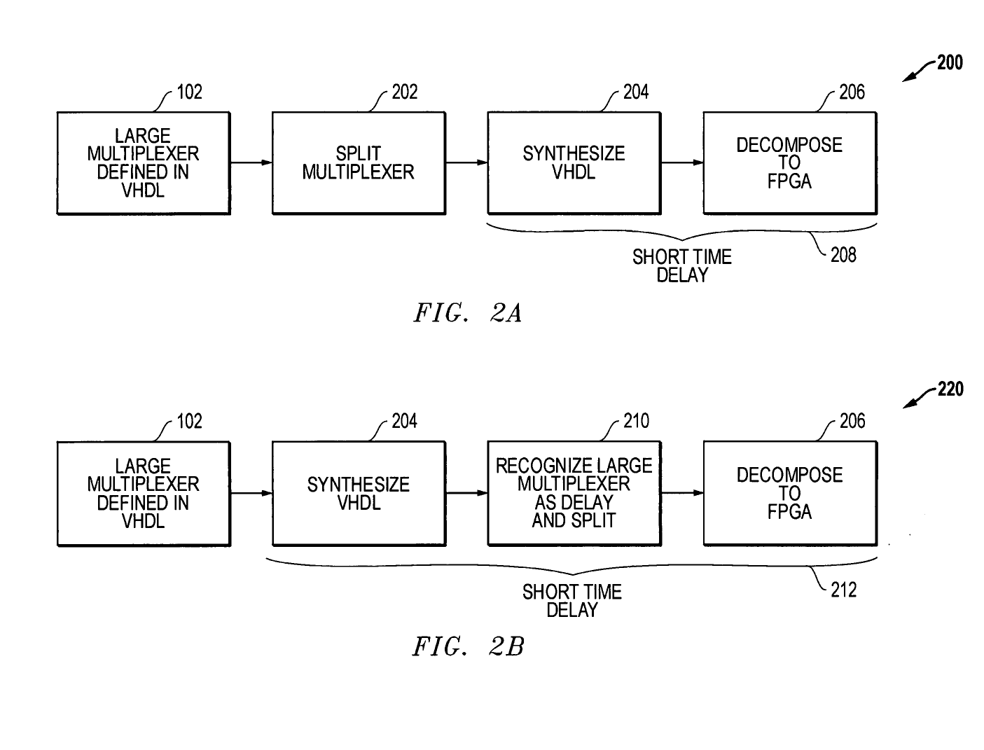

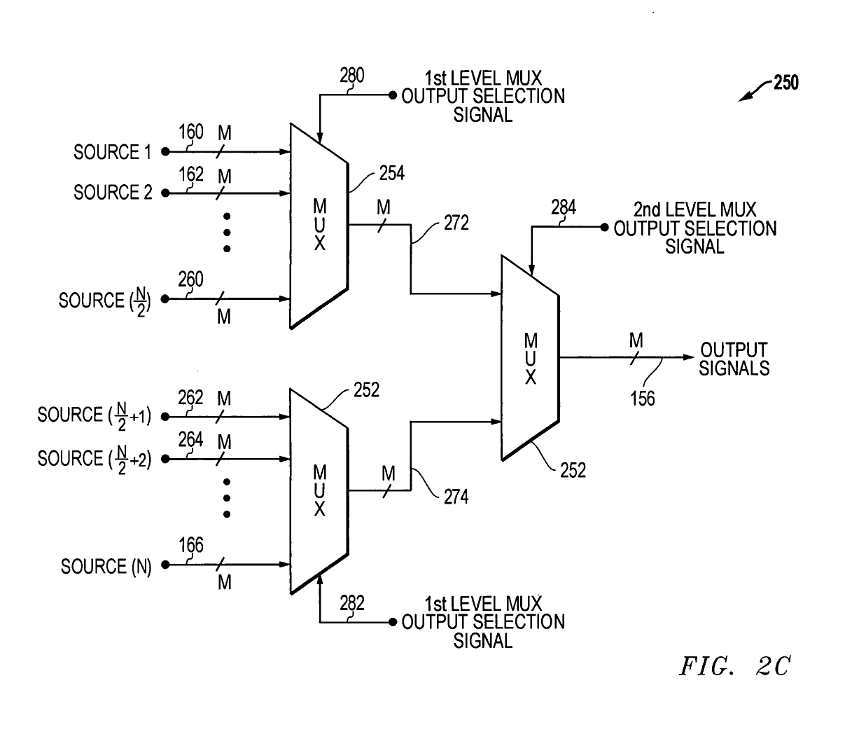

FIG. 2A provides a block diagram for a VHDL synthesis and decomposition process 200 in forming a large multiplexer within an FPGA where the large multiplexer is split into multiple levels. In step 102, a large multiplexer is described in VHDL, for example, as part of a larger device configured to operate and perform desired functions. In step 202, the large multiplexer is split into multiple levels of cascaded multiplexers within the VHDL code. In step 204, the VHDL is synthesized using a synthesis tool to form a hardware definition of gates and lines associated with the hardware described in the VHDL code, including the large multiplexer split into multiple cascaded levels. In step 206, the synthesized hardware is decomposed or mapped into an FPGA to form an integrated circuit device programmed to perform the desired functions as defined in the VHDL code, including the large multiplexer split into multiple cascaded levels. This method of splitting the large multiplexer prior to synthesizing and mapping the large multiplexer from VHDL to FPGAs significantly reduces processing time. As shown in FIG. 2A, a short time delay 208 is associated with the synthesis and decomposition process.

The split of the large multiplexer into multiple levels of cascaded multiplexers can be defined in VHDL, as desired. However, one technique is to split the large multiplexer into two or more multiplexers at a first level, and then use a second level multiplexer to choose between the output signals from the multiplexers in the first level. Below is an example VHDL description for a large multiplexer have 32 input lines per signal source that has been split in this way into two levels with two multiplexers at the first level (A_MUX and B_MUX).

| type | bus_array is array (natural range <>) of vector(31 downto 0); | |
|---|---|---|
| subtype | A_MUX_SEL_RANGE | is integer range 0 to gNUM_A_SOURCES-1; |
| signal | sA_MUX_SEL_INT | :A_MUX_SEL_RANGE; |
| subtype | B_MUX_SEL_RANGE | is integer range 0 to gNUM_B_SOURCES-1; |
| signal | sB_MUX_SEL_INT | :B_MUX_SEL_RANGE; |
| IF_BUS | :in | bus_array(0 to gNUM_SOURCES-1); |
| MUX_BUS | :out | vector(31 downto 0); |

| | | |
|---|---|---|
| MUX_BUS <= | sA_IF_BUS(sA_MUX_SEL_INT) | when (sA_ACTIVE); |
| else | sB_IF_BUS(sB_MUX_SEL_INT) | when (sB_ACTIVE); |
| else | (others => “0”); | |

(NOTE that gNUM_SOURCES-1 = gNUM_A_SOURCES-1 = gNUM_B_SOURCES-1)

This VHDL language represents a definition for a multiplexer where M is 32 and where the large multiplexer has been split into half to form a first multiplexer (A_MUX) and a second multiplexer (B_MUX). As part of a broader device description, VHDL code splitting large multiplexers can significant reduce the time required for the synthesize and decompose process.

As set forth above, splitting the large multiplexer can be manually done in the VHDL code itself if the user recognizes the problem or is informed of the problem. In addition, the FPGA synthesis and/or decomposition tools for handling VHDL could be configured and automated at least in part to identify and handle large multiplexers. A VHDL tool, for example, could determine whether a large multiplexer exists in the VHDL that could cause and/or will cause significant processing delays. The VHDL tool could then notify a user of the existence of the large multiplexer and the potential delay problem, and/or the VHDL tool could take automated action in splitting the large multiplexer into a multi-level cascaded multiplexer structure.

FIG. 2B is a flow diagram of a processing architecture 220 for converting VHDL code into hardware definitions and then decomposing those definitions into circuitry within an FGPA where a large multiplexer is split into multiple levels as part of the synthesis and decomposition process. In step 102, a large multiplexer is described in VHDL, for example, as part of a larger device configured to operate and perform desired functions. In step 204, the VHDL is synthesized using a synthesis tool to form a hardware definition of gates and lines associated with the hardware described in the VHDL code, including the large multiplexer. However, as represented by step 210, during this synthesis process, the tool recognizes that a large multiplexer is defined in the VHDL and that the large multiplexer may or will cause a delay in the synthesis and decomposition process. The large multiplexer is then split by the tool through an automated process or through interaction with the user. In step 206, the synthesized hardware is decomposed or mapped into an FPGA to form an integrated circuit device programmed to perform the desired functions as described in the VHDL code, including the large multiplexer split into multiple cascaded levels. This method of splitting the large multiplexer as part of the synthesis and mapping process from VHDL to FPGAs significantly reduces processing time. As shown in FIG. 2A, a short time delay 208 is associated with the synthesis and decomposition process.

It is noted that the FPGA related VHDL synthesis and/or decomposition tool could be configured in a variety of ways to handle the large multiplexer. For example, the user could pre-configure the tool such that it automatically splits large multiplexers in a particular way if the tool determines a significant delay will occur. In addition, user defined settings for such a pre-configuration could include specifying one or more parameters associated with large multiplexers as an indicator of when the tool should automatically split a multiplexer and, if so, how to split the multiplexer. These parameters could include the total number of inputs, the number of inputs per input signal source, the expected delay in processing, and any other desired parameter. In addition, user defined parameters could be associated with how the tool handles the large multiplexers. For example, such parameters could include the number of levels to create, the number of multiplexers per level to create, how the inputs are split, and any other desired parameter. As such, a wide variety of automated and/or user configured options could be set for handling large multiplexers to reduce the time for the synthesis/decomposition process to FPGAs.

FIG. 2C is a block diagram for a multi-level cascaded multiplexer structure 250 that could result from a synthesis and decomposition process according to FIG. 2B or FIG. 2C. In the example embodiment depicted, the multiplexer 152 of FIG. 1B has been split into a two-level cascaded multiplexer structure. First level multiplexer 254 and first level multiplexer 256 now receive a portion of the original inputs from the signal sources. Together, they still receive a plurality (N) of signal sources. However, now first level multiplexer 254 receives M signal lines 160 from SOURCE1, M signal lines 162 from SOURCE2 . . . thorough M signal lines 260 from SOURCE(N/2). The other first level multiplexer 256 receives M signal lines 262 from SOURCE(N/2+1), M signal lines 264 from SOURCE(N/2+2) . . . through M signal lines 166 from SOURCE(N). Thus, in the embodiment depicted, each first level multiplexer 254 and 256 receives one-half of the inputs. It is also noted that “N” again represents an integer number of signal sources, and “M” represents an integer number of signals lines associated with each signal source. As stated above, when N is 8 or greater and/or M is 16 or greater and/or the total number of input/output signals is 16 bits wide or greater, there is a likelihood that the multiplexer will cause significant processing delays. As such, by identifying and splitting a large multiplexer into multiple levels of cascaded multiplexers, the processing delay is greatly reduced.

Looking back to FIG. 2C, the first level multiplexer 254 receives a first (1^{st}) level MUX output selection signal 280 which acts to select which of the input signal sources the multiplexer 254 passes on as the M output signals 272. The other first level multiplexer 256 receives a first (1^{st}) level MUX output selection signal 282 which also acts to select which of the input signal sources the multiplexer 252 passes on as the M output signals 274. Second level multiplexer (MUX) 252 then receives as input signals the output signals 272 and 274 from multiplexer (MUX) 254 and multiplexer (MUX) 256, respectively. The second level multiplexer 252 then receives a second (2^{nd}) level MUX output selection signal 284 which acts to select which of the input signal sources the multiplexer 252 passes on as the M output signals 156.

While the embodiment depicted in FIG. 2C shows a large multiplexer being split into a two levels with the first level being two multiplexers and the second level being one multiplexer, it is understood that the large multiplexer can be split in a wide variety of manners to form a multiple level cascaded multiplexer structure. For example, the large multiplexer could be split into more than two levels, and the first level could include more than two multiplexer, if desired. In short, the cascaded multiplexer structure selected can be configured, as desired, depending any desired set of parameters. However, the more levels that are selected the more delay may be added into the operation of the end device because each multiplexer will typically add associated gate delays to the operation of the programmed FPGA. As such, there will likely be a trade-off between the speed of the synthesis/decomposition process that is gained by splitting multiplexer structures to reduce the size of the individual multiplexer circuitry and delays created by adding multiplexers and multiple cascaded levels of multiplexers. Each multiplexer level will typically have some delay associated with it. A four-level cascaded multiplexer structure, therefore, would cause a longer signal delay between the input signal sources and the final output signals than would a two-level cascaded multiplexer structure. Thus, splitting the multiplexers too much may cause undesirable performance degradations in the final FPGA.

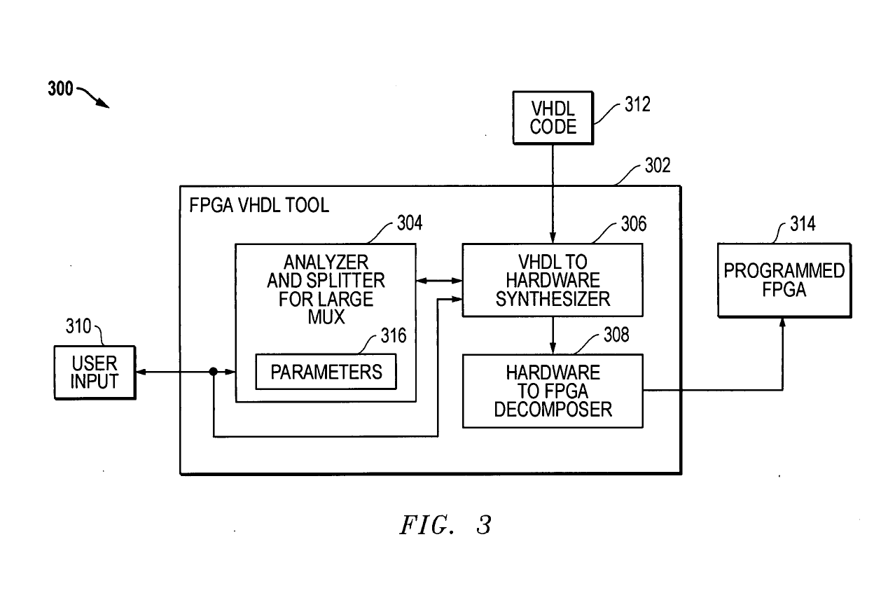

FIG. 3 is a block diagram 300 for a VHDL tool configured to identify and split large multiplexers within VHDL code. As depicted, the VHDL tool 302 includes a synthesizer 306, a decomposer 308, and an analyzer and splitter 304 for large multiplexers. The VHDL tool 302 receives as an input VHDL code 312. The synthesizer 306 takes this VHDL code 312 and synthesizes hardware definitions of gates and lines based upon the VHDL code. As part of this process or prior to this process, the synthesizer 306 communicates with the analyzer and splitter 304 to identify large multiplexers that may be defined within the VHDL code. The analyzer and splitter 304 is configured to utilize parameters 316 in identifying large multiplexers and splitting the large multiplexers into a multi-level cascaded multiplexer structure. The hardware output of synthesizer 306 is then processed by the decomposer 308 to configure and form circuitry within a programmed FPGA 314. It is noted that the parameters 316 may be any desired parameter or combination of parameters that can be used alone or in combination to facilitate the identification of multiplexers that may cause processing delays and thereby be designated as large multiplexers that could be split to improve processing. Parameters such as the number of signal sources, the number of signal destinations, the total number of input signals, the total number of output signals, the number of signals per input source, the number of signals per output source, and/or any other desired parameter can be used alone or in combination as the parameters 316.

As depicted, user input 310 can also be provided to analyzer and splitter 304, for example, to adjust or set user-defined parameters for parameters 316 in order to configure the operation of the analyzer and splitter 304. User input 310 can also be provided to the synthesizer 306, for example, if synthesizer 306 is seeking user input as to whether or not a large multiplexer that has been identified should in fact be split into multiple levels.

It is noted that the embodiment 300 is only an example and that other variations and configurations could be used to implement a VHDL tool or VHDL system that configures FPGA circuitry from VHDL code with reduced delay from large multiplexers.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. A method for configuring FPGA (field programmable gate array) circuitry from VHDL (Very high speed integrated circuit Hardware Description Language) code with reduced delay from large multiplexers, comprising:
analyzing VHDL code;
identifying a large multiplexer defined within the VHDL code based upon one or more parameters;
splitting the large multiplexer into a multiple level multiplexer structure including a plurality of smaller multiplexers;
synthesizing the VHDL code to create hardware definitions; and
decomposing the hardware definitions into FPGA circuitry.

2. The method of claim 1, wherein the identifying step comprises identifying a multiplexer that has 8 or more input signal sources as a large multiplexer.

3. The method of claim 1, wherein the identifying step comprises identifying a multiplexer that is 16 or more bits wide for a total number of input signals as a large multiplexer.

4. The method of claim 1, wherein the splitting step comprises splitting the large multiplexer into two levels of cascaded multiplexers.

5. The method of claim 4, wherein the splitting step comprises splitting the large multiplexer into two first level multiplexers followed by one second level multiplexer.

6. The method of claim 1, wherein the splitting step comprises splitting the large multiplexer into more than two levels of cascaded multiplexers.

7. The method of claim 1, wherein the analyzing, identifying and splitting steps are performed automatically by a VHDL tool.

8. The method of claim 7, further comprising allowing user defined parameters to be set within the VHDL tool to control at least in part the analyzing, identifying and splitting steps.

9. The method of claim 1, wherein the analyzing and identifying are performed by a VHDL tool and further comprising communicating to a user the existence of a large multiplexer and allowing the user to determine whether or not the splitting step is performed.

10. The method of claim 1, further comprising using a total number of input signals and a number of signals per input source as parameters in the identifying step.

11. A system for configuring FPGA (field programmable gate array) circuitry from VHDL (Very high speed integrated circuit Hardware Description Language) code with reduced delay from large multiplexers, comprising:
an input configured to receive VHDL code;
a synthesizer configured to receive the VHDL code and to synthesize hardware definitions from the VHDL code;
an analyzer and splitter for large multiplexers configured to communicate with the synthesizer to identify large multiplexers within the VHDL code based upon one or more parameters and to split large multiplexers once identified;
a decomposer configured to receive the hardware definitions from the synthesizer and to program FPGA circuitry including any large multiplexer identified and split.

12. The system of claim 11, wherein the parameters are configured to identify a multiplexer that has 8 or more input signal sources as a large multiplexer.

13. The system of claim 11, wherein the parameters are configured to identify a multiplexer that is 16 or more bits wide for a total number of input signals as a large multiplexer.

14. The system of claim 11, wherein the analyzer and splitter is configured to split a large multiplexer into two levels of cascaded multiplexers.

15. The system of claim 14, wherein the analyzer and splitter is configured to split the large multiplexer into two first level multiplexers followed by one second level multiplexer.

16. The system of claim 11, wherein the analyzer and splitter is configured to split the large multiplexer into more than two levels of cascaded multiplexers.

17. The system of claim 11, wherein the analyzer and splitter is configured to operate automatically.

18. The system of claim 17, wherein at least one or more of the parameters are configured to be set by user input.

19. The system of claim 11, wherein one of the parameters comprises an indication from a user regarding whether an identified multiplexer is to be split.

20. The system of claim 11, wherein the parameters including a total number of input signals and a number of signals per input source.
